(19) United States
(12) Patent Application Publication
(10) Pub. No.: US 2006/0162834 A1
(43) Pub. Date: Jul. 27, 2006

(54) VEHICLE WHEEL RIM ASSEMBLY

(76) Inventor: Yueh Nu Chen, I Lan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/041,740

(22) Filed: Jan. 25, 2005

(51) Int. Cl. B60C 15/06

(52) U.S. Cl. 152/381.6

(57) ABSTRACT

A wheel rim is constructed to include a wheel rim body holding a tire, a mounting ring formed of two semicircular frame bars and mounted on the wheel rim body to hold a packing rubber, and a supplementary tire support mounted on the mounting ring around the wheel rim body and supported on the packing rubber for supporting the tire for enabling the car to run to a repair shop in case the tire is broken during running.

### BACKGROUND OF THE INVENTION

1. Field of the Invention

The present invention relates generally to a motor vehicle and more particularly, to a vehicle wheel rim assembly that allows the car driver to drive the car to the car shop safety for receiving a repair work when the tire is broken.

2. Description of the Related Art

When the tire of a vehicle wheel is inflated, high-pressure air supports the tire in shape for running on the road. If a pointed body pierced the tire, the broken tire becomes unable to support the vehicle wheel for normal running on the road, and the broken tire must be repaired immediately. However, It is dangerous if one of the wheels of a vehicle is broken during a high speed running.

### SUMMARY OF THE INVENTION

The present invention has been accomplished under the circumstances in view. It is the main object of the present invention to provide a wheel rim assembly for vehicle tire, which supports the tire in shape for enabling the car to run to a repair shop in case the tire is broken during running. To achieve this and other objects of the present invention, the wheel rim assembly comprises a wheel rim body holding a tire, a mounting ring mounted on the wheel rim body, the mounting ring being comprised of two semicircular frame bars, the semicircular frame bars each having an inner mounting wall fitting the periphery of the wheel rim body, an outer mounting groove formed in an outer wall thereof, a lever-operated hook at a first end thereof, and a retaining loop at a second end thereof, the lever-operated hook of one of the semicircular frame bars being connectable to the retaining loop of the other of the semicircular frame bars, a packing rubber mounted in the outer mounting grooves of the semicircular frame bars, and a supplementary tire support mounted on the packing rubber around the mounting ring.

### BRIEF DESCRIPTION OF THE DRAWINGS

FIG. 1 is an exploded view of a mounting ring for wheel rim assembly according to the present invention.

FIG. 2 is an enlarged view of a part of FIG. 1.

FIG. 3 is a schematic drawing showing the mounting ring fits different wheel rim bodies.

FIG. 4 is an exploded view of a part of a supplementary tire support for wheel rim assembly according to the present invention.

FIG. 5 is an exploded view of another part of the supplementary tire support for wheel rim assembly according to the present invention.

FIG. 6 is a perspective view of a part of the supplementary tire support for wheel rim assembly according to the present invention, showing the relationship between the first end connecting member and the second end connecting member.

FIG. 7 corresponds to FIG. 5 showing the first end connecting member and the second end connecting member fastened together.

FIG. 8 is an exploded view of a part of the wheel rim assembly according to the present invention.

FIG. 9 is an exploded view of a part of the wheel rim assembly according to the present invention, showing the mounting ring fastened to the wheel rim body before installation of the packing rubber.

FIG. 10 is a schematic drawing showing a screwdriver inserted into the recessed portion and the hanger moved according to the present invention.

FIG. 11 is a sectional view showing the wheel rim assembly fastened to the inside of a tire according to the present invention.

FIG. 12 is a cross-sectional view in an enlarged scale of FIG. 11.

FIG. 13 corresponds to FIG. 12, showing the tire broken and supported on the supplementary tire support.

### DETAILED DESCRIPTION OF THE INVENTION

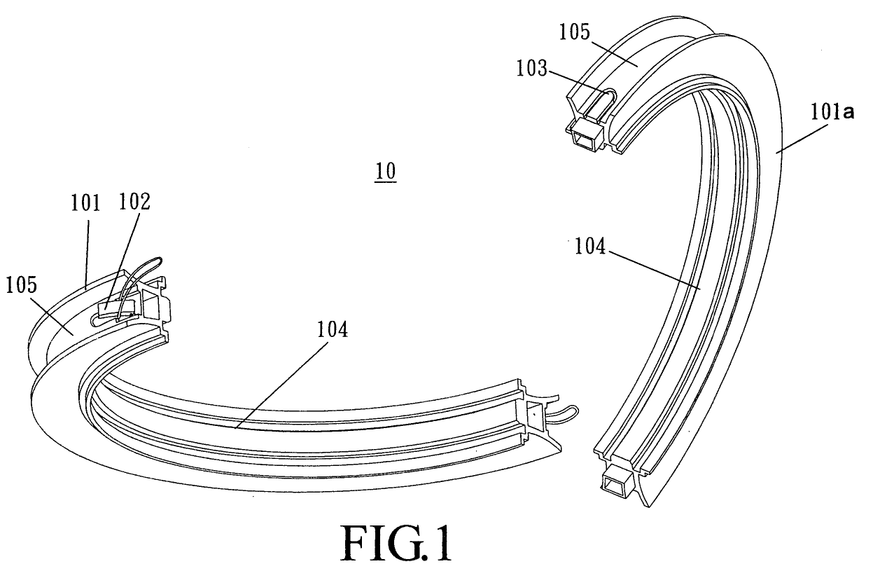

Referring to FIGS. 1˜9, a wheel rim assembly in accordance with the present invention is shown comprised of a wheel rim body 60, a mounting ring 10, and a supplementary tire support 20.

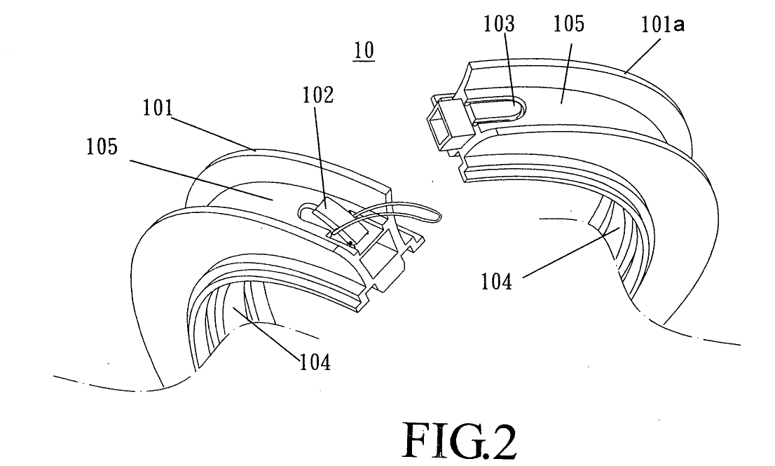

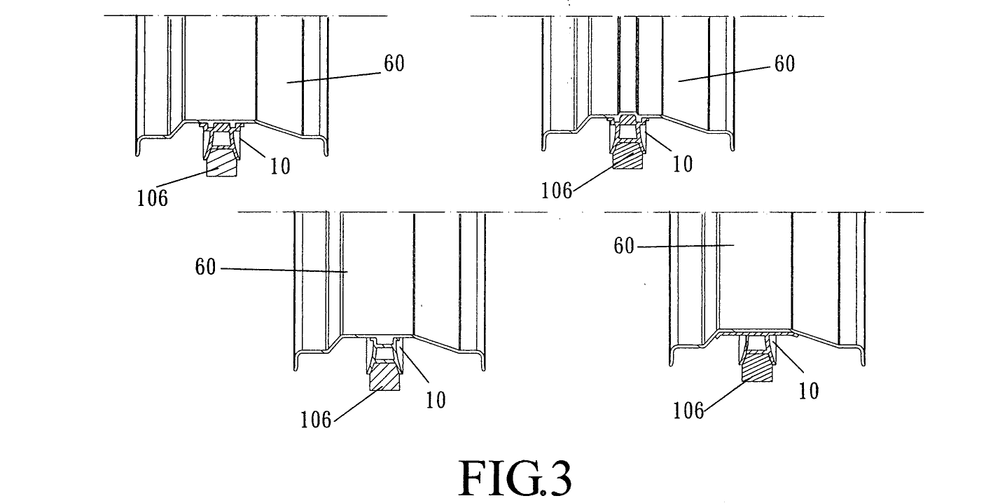

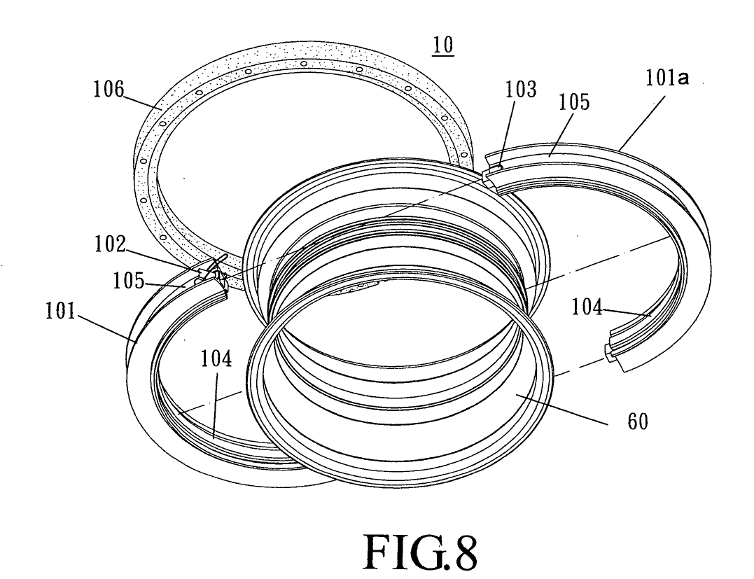

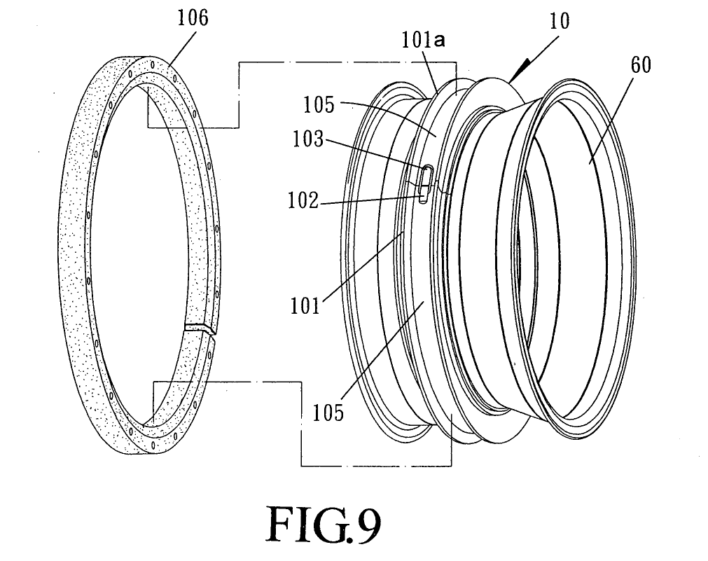

The mounting ring 10 is comprised of two semicircular frame bars 101 and 101a (see FIGS. 1 and 2). The semicircular frame bars 101 and 101a each have an inner mounting wall 104 fitting the periphery of the wheel rim body 60, and an outer mounting groove 105 formed in the outer wall thereof and extending along the length for receiving a packing rubber 106 (see FIG. 3). The semicircular frame bars 101 and 101a each further has a lever-operated hook 102 at one end and a retaining loop 103 at the other end. By means of fastening the lever-operated hook 102 of one semicircular frame bar 101 or 101a to the retaining loop 103 of the other semicircular frame bar 101a or 101, the two semicircular frame bars 101 and 101a are connected together and fastened to the periphery of the wheel rim body 60 (see FIGS. 8 and 9)

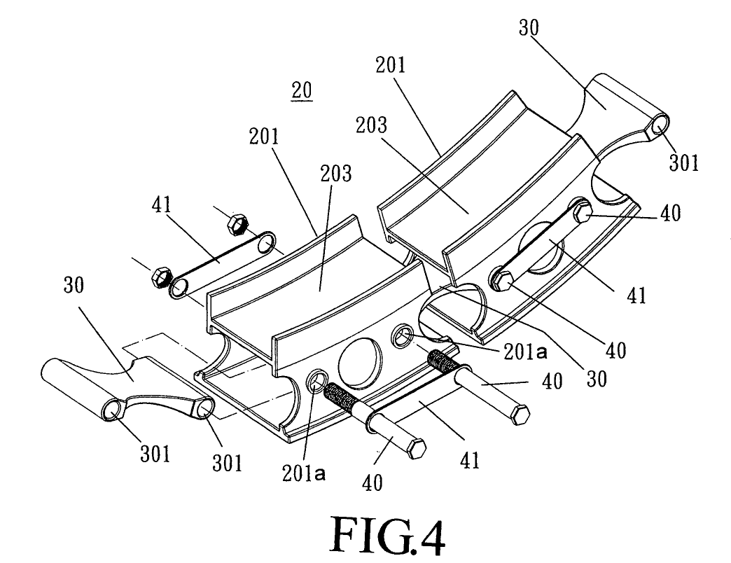

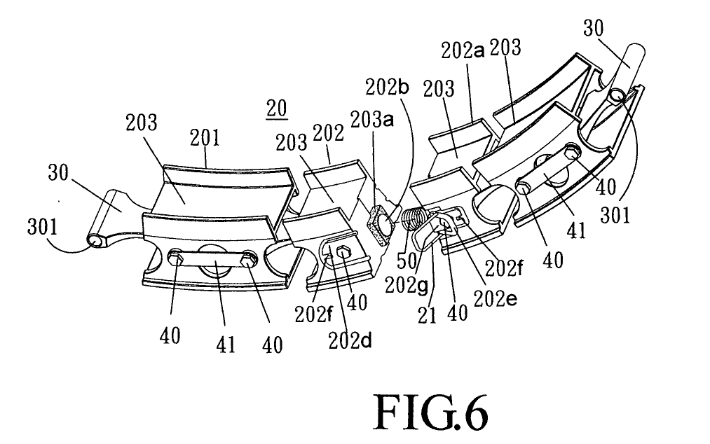

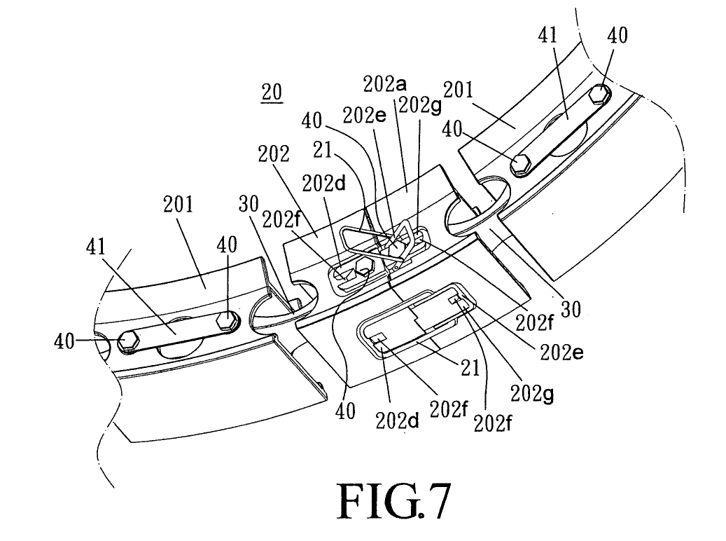

Referring to FIGS. 4 through 7 again, the supplementary tire support 20 is mounted on the packing rubber 16 around the mounting ring 10, comprised of a plurality of joint blocks 201, a plurality of links 30, a first end connecting member 202, a second end connecting member 202a, a plurality of screw bolts 40, a plurality of elongated packing plates 41, and a tensile spring 50.

The joint blocks 201 each have two mounting through holes 201a transversely extending through the two opposite lateral sidewalls thereof near the front and rear ends for mounting.

The links 30 connect the joint blocks 201 in series, each comprising two mounting holes 301 transversely extending through two opposite lateral sidewalls thereof near the front and rear ends and respectively one mounting through hole 201a of each of two adjacent joint blocks 201.

The elongated packing plates 41 are respectively attached to the two opposite lateral sidewalls of each of the joint blocks 201.

The screw bolts 40 are respectively fastened to the two eyed-ends of the elongated packing plates 41, the mounting through holes 201a of the joint blocks 201 and the mounting holes 301 of the links 30 to connect the joint blocks 201 in series.

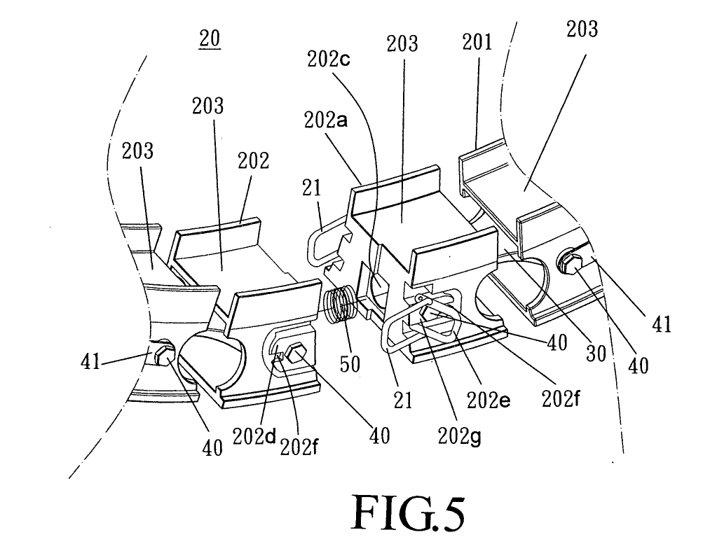

The first end connecting member 202 and the second end connecting member 202a are connected together to join the ends of the series of joint blocks 20 (see FIGS. 5˜7). The first end connecting member 202 comprises a front coupling rod 202b, a cushion 203a around the root of the front coupling rod 202b, and two hooks 202d symmetrically disposed at two opposite lateral sides. The second end connecting member 202a comprises a front coupling hole 202c for receiving the front coupling rod 202b of the first end connecting member 202, two hangers 21 respectively pivotally provided at two opposite lateral sides thereof for hooking on the hooks 202d at the first end connecting member 202, two locking levers 202e adapted to move the hangers 21 between the locking position and the unlocking position, and two hooks 202g for holding the locking levers 202e in the received position. Further, the end connecting member 202 or 202a has two recessed portions 202f symmetrically formed in the two opposite lateral sides corresponding to the hooks 202d or locking lever 202e.

The tensile spring 50 is mounted on the coupling rod 202b of the first end connecting member 202 and supported between the cushion 203a and the second end connecting member 202a around the coupling hole 202c.

Further, the joint blocks 201 and the end connecting members 202 and 202a each have an inner mounting groove 203 fitting the packing rubber 106 around the mounting ring 10.

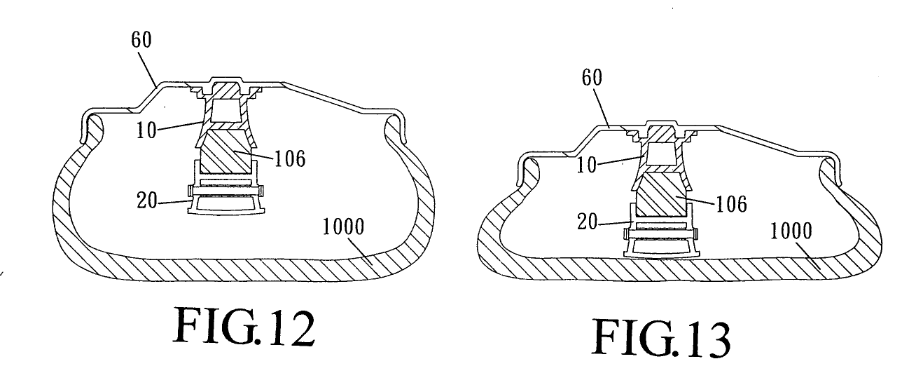

Referring to FIGS. 11 and 12 and FIGS. 8 and 9 again, the tire 1000 is fastened to one side of the wheel rim body 60 at first, and then the semicircular frame bars 101 and 101a are inserted into the inside of the tire 1000 and joined together around the wheel rim body 60, and then the packing rubber 106 is fastened to the outer mounting grooves 105 of the semicircular frame bars 101 and 101a of the mounting ring 10, and then the first and second end connecting members 202 and 202a of the supplementary tire support 20 are fastened together to secure the supplementary tire support 20 to the packing rubber 106 at the mounting ring 10 around the wheel rim body 10 within the tire 1000.

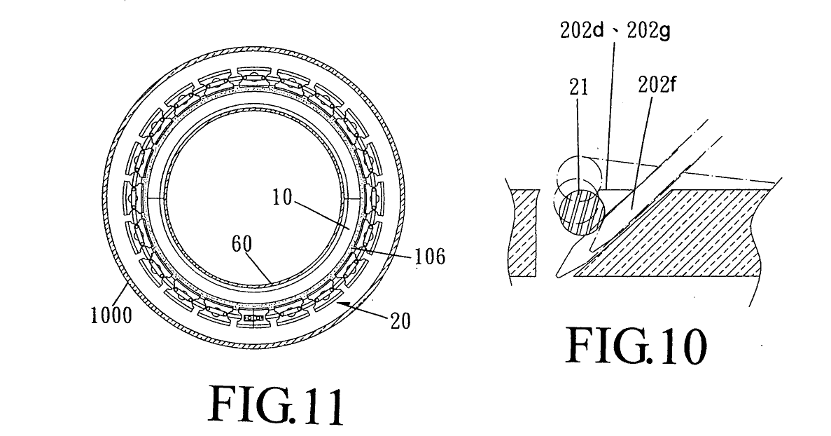

Referring to FIG. 10, when wishing to remove the supplementary tire support 20 from the mounting ring 10 and the wheel rim body 10, insert a screwdriver or the like into the recessed portion 202f to lift the respective locking lever 202e and hanger 21 from the respective hook 202g or 202d.

Referring to FIG. 13, when the tire 1000 is broken, the supplementary tire support 20 support the broken tire 1000, enabling the driver to drive the car to a vehicle repair shop for repair. Further, the packing rubber 106 absorbs shocks from the supplementary tire support 20.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A wheel rim assembly comprising:
a wheel rim body;
a mounting ring mounted on said wheel rim body, said mounting ring being comprised of two semicircular frame bars, said semicircular frame bars each having an inner mounting wall fitting the periphery of said wheel rim body, an outer mounting groove formed in an outer wall thereof, a lever-operated hook at a first end thereof, and a retaining loop at a second end thereof, the lever-operated hook of one of said semicircular frame bars being connectable to the retaining loop of the other of said semicircular frame bars;
a packing rubber mounted in the outer mounting grooves of said semicircular frame bars; and
a supplementary tire support mounted on said packing rubber around said mounting ring, said supplementary tire support comprising a plurality of joint blocks, said joint blocks each having two mounting through holes transversely extending through two opposite lateral sidewalls thereof near two distal ends, a plurality of links respectively connected between each two of said joint blocks, said links each having two mounting holes transversely extending through two opposite lateral sidewalls thereof near two distal ends and respectively connected to the mounting through holes of said joint blocks, a plurality of elongated packing plates respectively attached to said joint blocks at two sides, a plurality of screw bolts respectively fastened to two eyed-ends of each of said elongated packing plates, the mounting through holes of said joint blocks and the mounting holes of said links to connect said joint blocks and said links into an end block series, a first end connecting member connected to a first end of said end block series, and a second end connecting member connected to a second end of said end block series and connectable to said first end connecting member, said first connecting member comprising a front coupling rod, a cushion around a root of said front coupling rod, and two hooks symmetrically disposed at two opposite lateral sides thereof, said second end connecting member comprising a front coupling hole for receiving said front coupling rod of said first end connecting member, two hangers respectively pivotally provided at two opposite lateral sides thereof for hooking on the hooks at said first end connecting member, two locking levers adapted to move said hangers between a locking position and am unlocking position, and tensile spring mounted on said coupling rod of said first end connecting member and supported between said cushion of said first end connecting member and said second end connecting member.
